(19) United States
(12) Patent Application Publication
(10) Pub. No.: US 2024/0005079 A1
(43) Pub. Date: Jan. 4, 2024

(54) POWER LINE ARRANGEMENT METHOD ANDMEMORY DEVICE

(71) Applicant: Samsung Electronics Co., Ltd., Suwon-si (KR)

(72) Inventor: Jonghyeok KIM, Suwon-si (KR)

(73) Assignee: Samsung Electronics Co., Ltd., Suwon-si (KR)

(21) Appl. No.: 18/319,049

(22) Filed: May 17, 2023

(30) Foreign Application Priority Data
Jul. 4, 2022 (KR) 10-2022-0082132

(51) Int. Cl. G06F 30/394; G06F 30/36

(52) U.S. Cl. CPC G06F 30/394; G06F 30/36; G06F 2113/18

(57) ABSTRACT

A method of arranging power lines to be applied to a memory device including a plurality of layers, wherein, in each of the plurality of layers, a plurality of power lines and a plurality of signal lines are arranged along a plurality of track lines arranged side by side to be separated from each other in a first direction or a second direction that is perpendicular to the first direction is provided. The method includes identifying a first track line on which a plurality of power lines are arranged, moving at least one of the plurality of power lines to a second track line adjacent to the first track line, and electrically connecting the moved at least one power line on the second track line.

### CROSS-REFERENCE TO RELATED APPLICATION

This application is based on and claims priority under 35 U.S.C. § 119 to Korean Patent Application No. 10-2022-0082132, filed on Jul. 4, 2022, in the Korean Intellectual Property Office, the disclosure of which is incorporated by reference herein in its entirety.

### BACKGROUND

Inventive concepts relate to a power line arrangement method and/or a memory device.

A semiconductor memory device requires or expects to use various operating voltages, such as one or more of an external power source voltage, an internal power source voltage, a ground voltage, and a reference voltage, to access data, e.g. for reading and/or writing of data. The operating voltages may be transferred through power lines.

### SUMMARY

Example embodiments provide a power line arrangement method capable of reducing a current-resistance (IR) drop, by using a white space.

According to some example embodiments, there is provided a power line arrangement method.

The power line arrangement method of arranging power lines may be applied to a memory device including a plurality of layers, wherein, in each of the plurality of layers, a plurality of power lines and a plurality of signal lines are arranged along a plurality of track lines side by side to be separated from each other in a first direction or a second direction that is perpendicular to the first direction. The method may include identifying a first track line on which a plurality of power lines are arranged, moving at least one of the plurality of the plurality of power lines to a second track line adjacent to the first track line, and electrically connecting the moved at least one power line on the second track line.

According to various example embodiments, there is provided a power line arrangement method.

The power line arrangement method includes arranging first power lines and second power lines on each of a plurality of layers by using a power plan, arranging signal lines by routing each of the plurality of layers, and connecting each of the first power lines and/or each of the second power lines within a range not interfering with the routed signal lines.

According to various example embodiments, there is provided a memory device.

The memory device includes a plurality of layers including a first layer in which a plurality of first power lines and a plurality of first ground lines are arranged along a plurality of first track lines arranged in a first direction, and a second layer in which a plurality of second power lines and a plurality of second ground lines are arranged along a plurality of second track lines arranged in a second direction that is perpendicular to the first direction, and which is adjacent to the first layer in a Z-axis direction. A first power line arranged in the first layer is connected with a second power line arranged in the second layer through a first via, a first ground line arranged in the first layer is connected with a second ground line arranged in the second layer through a second via, the plurality of first power lines or the plurality of first ground lines that are arranged in the first layer are electrically isolated in the first layer, and each of at least some of the plurality of second power lines or at least some of the plurality of second ground lines arranged in the second layer is electrically connected in the second layer.

### BRIEF DESCRIPTION OF THE DRAWINGS

Various example embodiments of various example embodiments will be more clearly understood from the following detailed description taken in conjunction with the accompanying drawings in which:

FIG. 1 is a flowchart illustrating a method of designing and manufacturing a memory device, according to some example embodiments;

FIG. 2 is a schematic top view of a memory device according to some example embodiments;

FIG. 3A is a perspective view illustrating a first layer and a second layer of a memory device according to some example embodiments, and FIG. 3B is a top view illustrating the first layer and the second layer of FIG. 3A;

FIGS. 4A to 4D are top views illustrating a method of arranging power lines in a memory device, according to some example embodiments;

FIGS. 5A to 5D are top views illustrating a method of arranging power lines in a memory device, according to some example embodiments;

FIGS. 6A to 6D are top views illustrating a method of arranging power lines in a memory device, according to some example embodiments;

FIGS. 7A to 7E are top views illustrating a method of arranging power lines in a memory device, according to some example embodiments;

FIGS. 8A and 8B are flowcharts illustrating a power line arrangement method according to some example embodiments;

FIGS. 9A and 9B are flowcharts illustrating a power line arrangement method according to some example embodiments;

FIG. 10 is a block diagram of a system on chip according to some example embodiments;

FIG. 11 is a block diagram of a mobile device according to some example embodiments; and

FIG. 12 is a block diagram of a computing device according to some example embodiments.

### DETAILED DESCRIPTION OF VARIOUS EXAMPLE EMBODIMENTS

Hereinafter, embodiments are described below with reference to the accompanying drawings.

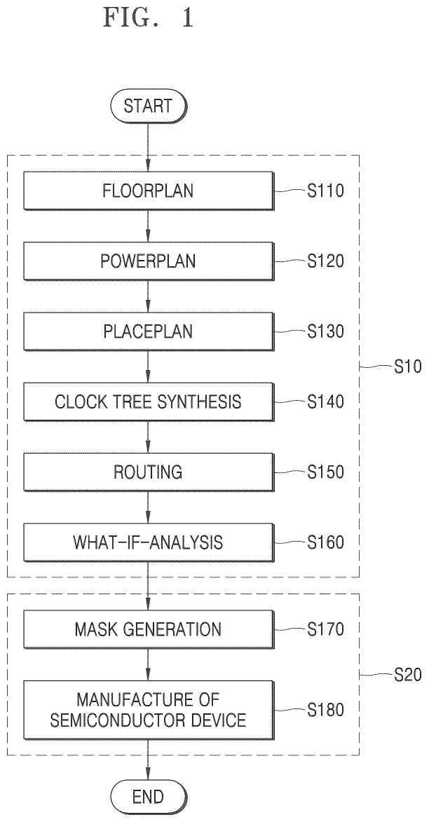

FIG. 1 is a flowchart illustrating a method of designing and manufacturing a semiconductor memory device, according to some example embodiments.

Referring to FIG. 1, the method of designing and manufacturing a semiconductor memory device may include a semiconductor memory device design operation S10 and a semiconductor memory device manufacturing/fabrication process operation S20. The semiconductor memory device design operation S10 is or includes an operation of designing a layout for a circuit, and may be performed using one or more tools for designing the circuit. The tool may be or may include a program including a plurality of instructions to be performed by one or more processors. Accordingly, the semiconductor memory device design operation S10 may be or may include a computer-implemented operation for a circuit design. The semiconductor memory device manufacturing process operation S20 is or includes an operation of manufacturing a semiconductor memory device based on the designed layout and may be performed by a semiconductor process module, e.g. a portion of a semiconductor process fabrication facility.

The semiconductor memory device design operation S10 may include a floorplan operation S110, a power plan operation S120, a place plan operation S130, a clock tree synthesis (CTS) operation S140, a routing operation S150, a staple line insertion operation S155, and a what-if-analysis operation S160.

The floorplan operation S110 may be or may include an operation of performing a physical design by cutting and moving a logically designed schematic circuit. In the floorplan operation S110, a memory and/or a function block may be arranged. For example, function blocks that are supposed to or are intended to be adjacently arranged may be identified, and a space for the function blocks may be allocated by considering various properties such as one or more of a usable space, a required performance, and/or the like. For example, the floorplan operation S110 may include generating a site-row, and forming a metal routing track on the generated site-row. The site-row is or includes a frame for arranging standard cells stored in a cell library, according to a defined design rule. The metal routing track is or includes a virtual line on which wirings are to be formed later.

The power plan operation S120 may be or may include an operation of arranging patterns of wirings connecting a local power source, e.g., a driving voltage or a ground voltage, to the arranged function blocks. For example, patterns of wirings connecting a power source or the ground may be generated to evenly supply power to the entire chip in a net form. The patterns may include power rails, and the patterns may be generated in a net form based on various rules such as various design rules. According to some example embodiments, in the power plan operation S120, power lines may be primarily arranged. In the power plan operation S120, power lines may be arranged along a track region that is a routable region. According to some example embodiments, in the power plan operation S120, power lines may be arranged in the same track region.

The place plan operation S130 is or includes an operation of arranging patterns of devices constituting the function blocks and may include arranging standard cells. Particularly, in various example embodiments, each of the standard cells may include semiconductor devices and first wiring lines connected thereto. The first wiring lines may include a power transmission line connecting a power source or the ground. The first wiring lines may also include a signal transmission line, through which one or more of a control signal, an input signal, or an output signal is transmitted. Empty regions may be generated between the standard cells arranged in the present operation, and the empty regions may be filled with filler cells. Unlike the standard cells including an operable semiconductor device, a unit circuit implemented by semiconductor devices, and the like, the filler cells may be or correspond to a dummy region. The dummy region may be a region that is not electrically active during operation of the semiconductor device, and rather may be regions that help support manufacturability of the semiconductor device. As used herein, the shapes and/or sizes of the patterns for forming transistors and wirings to be actually formed on a semiconductor substrate may be defined. For example, to actually form an inverter circuit on the semiconductor substrate, layout patterns, such as a positive channel metal oxide semiconductor (PMOS), a negative channel metal oxide semiconductor (NMOS), an N-type well (N-WELL), a gate electrode, and wirings such as vias and/or metal runners to be arranged thereon, may be appropriately arranged.

The CTS operation S140 may be or may include an operation of generating patterns of signal lines for a center clock related to a response time by which the performance of a semiconductor memory device is determined.

The routing operation S150 may be or may include an operation of generating an upper wiring structure or a routing structure including second wiring lines connecting the arranged standard cells. The second wiring lines may be electrically connected to the first wiring lines in the standard cells, and may be electrically connect the standard cells to each other and/or to the power source or the ground. The second wiring lines may be configured to be physically formed above the first wiring lines. According to some example embodiments, the routing operation S150 may include an initial routing operation and/or a final routing operation. The initial routing operation may indicate an operation of first generating a routing structure including signal lines to which a clock signal and the like are applied. The final routing operation may indicate a routing operation finally performed after addition of standard cells ends. A power line arrangement method according to various example embodiments may be performed after the routing operation S150. The power line arrangement method according to various example embodiments may be performed after the initial routing operation of the routing operation S150. Alternatively or additionally, the power line arrangement method according to various example embodiments may be performed after the final routing operation of the routing operation S150. The power line arrangement method according to various example embodiments may include arranging a power line by using a white space after generating the routing structure including the signal lines to which the clock signal and the like are applied. Therefore, the power line arrangement method according to various example embodiments may be performed in an operation after generating the routing structure including the signal lines to which the clock signal and the like are applied. According to some example embodiments, the power line arrangement method according to various example embodiments may be performed in an engineering change order (ECO) operation. The power line arrangement method is particularly described below.

The what-if-analysis operation S160 may be or may include an operation of verifying and correcting the generated layout. Verification items may include one or more of a design rule check (DRC) for verifying whether a layout conforms to a design rule, an electronical rule check (ERC) for verifying whether inside electrical connection is normal, a layout versus schematic (LVS) for checking whether the layout matches a gate-level net list, and the like.

The semiconductor memory device manufacturing process operation S20 may include mask generation operation S170 and semiconductor memory device manufacturing operation S180.

The mask generation operation S170 may include generating mask data for forming various patterns in a plurality of layers by performing optical proximity correction (OPC) and the like on layout data generated in the semiconductor memory device design operation S10, and manufacturing or cutting a mask by using the mask data. The OPC may be performed to correct a distortion phenomenon which may occur in a photolithography process. The mask may be manufactured by using a chromium thin film coated on a glass or quartz substrate to draw layout patterns. The mask may be manufactured with an electron-beam manufacturing process; however, example embodiments are not limited thereto.

In the semiconductor memory device manufacturing operation S180, exposure and etching processes of various schemes may be iteratively or recursively performed. Through these processes, shapes of patterns configured in a layout design may be sequentially formed on a silicon substrate.

For example, a semiconductor memory device having an integrated circuit implemented thereon by using a plurality of masks to perform various semiconductor processes on a semiconductor substrate, such as a wafer is formed. The semiconductor processes may include a deposition process such as a chemical vapor deposition (CVD) process, an etching process such as a reactive ion etching (RIE) process and/or a wet etching process, an ionization process, a cleaning process, and/or the like. In some example embodiments, the semiconductor processes may include a packaging process of mounting the semiconductor memory device on a printed circuit board (PCB) and sealing the mounted semiconductor memory device with a sealing material, and a test process of testing the semiconductor memory device or a package thereof.

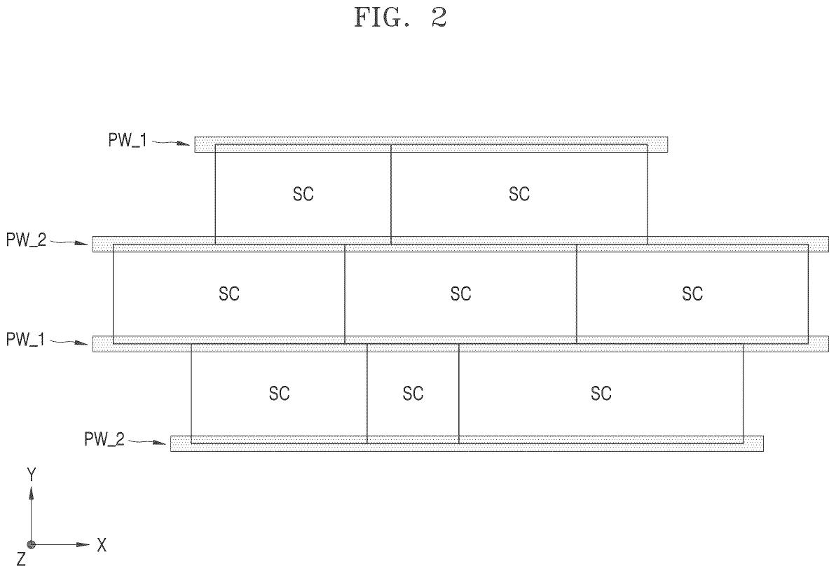

FIG. 2 is a schematic top view of a semiconductor memory device according to some example embodiments.

Referring to FIG. 2, the semiconductor memory device may include standard cells SC. The standard cells SC may be arranged in an X-axis direction (a first direction) and a Y-axis direction (a second direction). The semiconductor memory device may include first and second power lines PW_1 and PW_2, through which power is to be supplied to the standard cells SC. Although not shown, the semiconductor memory device may include filler cells arranged between the standard cells SC to provide a dummy region.

The first and second power lines PW_1 and PW_2 may be or may correspond to power rails and extend in the X-axis direction. Each of the first and second power lines PW_1 and PW_2 may extend along boundaries of the standard cells SC. The first and second power lines PW_1 and PW_2 may be arranged to be separated from each other in the second direction Y. A power line among the first and second power lines PW_1 and PW_2, which is arranged on a boundary between standard cells SC adjacent in the Y-axis direction, may be a power line shared by the adjacent standard cells SC.

The first and second power lines PW_1 and PW_2 may supply respective potentials to each of the standard cells SC arranged therebetween. For example, the first power lines PW_1 may supply first power VDD to the standard cells SC, the second power lines PW_2 may supply second power VSS to the standard cells SC, and the first power VDD may be higher than the second power VSS.

According to some example embodiments, the first and second power lines PW_1 and PW_2 may be arranged in a plurality of layers above the standard cells SC. The first and second power lines PW_1 and PW_2 arranged in the plurality of layers may be arranged in each layer, the first power lines PW_1 may be electrically connected between different layers through or by vias, and the second power lines PW_2 may be electrically connected between different layers through or by vias.

A method of arranging the first and second power lines PW_1 and PW_2 and a memory device to which the arrangement method is applied are described in more detail.

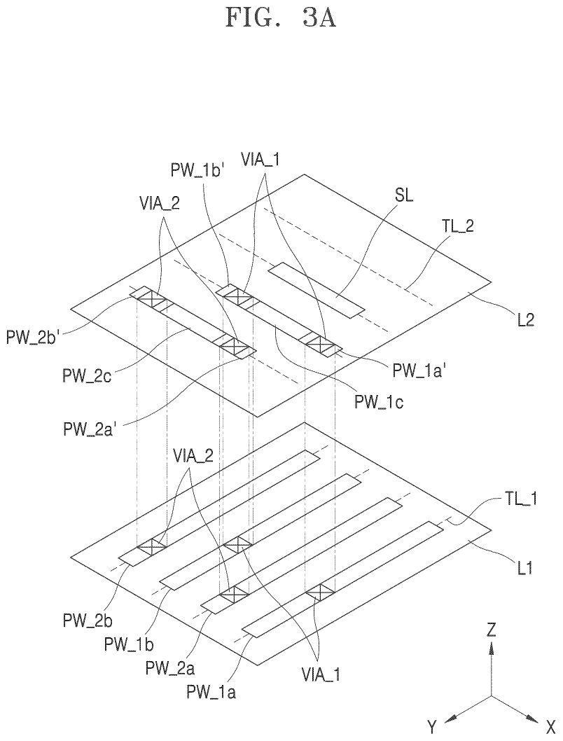

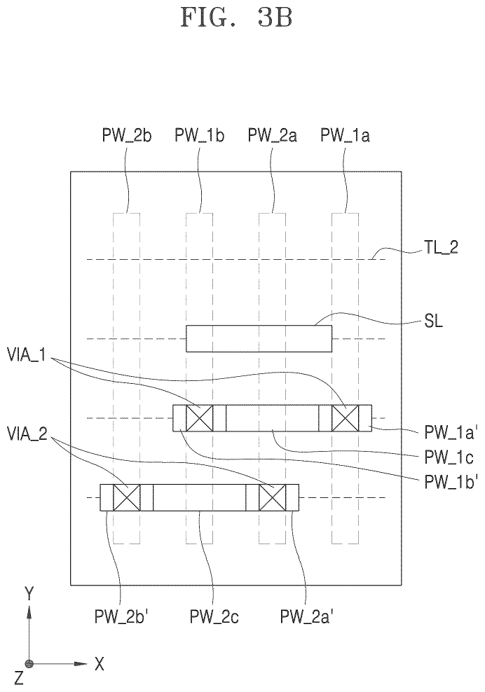

FIG. 3A is a perspective view illustrating a first layer L1 and a second layer L2 of a memory device according to some example embodiments.

Referring to FIG. 3A, the first layer L1 and the second layer L2 included in the memory device according to some example embodiments are shown. The memory device according to various example embodiments may include a plurality of layers, but in the memory device of FIG. 3A, only the first layer L1 and the second layer L2 adjacent in a Z-axis direction are shown for convenience of description. In some example embodiments, a first photomask may be manufactured based on the first layer L1, and a second photomask may be manufactured based on the second layer L2. According to some example embodiments, first and second track lines TL_1 and TL_2 may be included in the first layer L1 and the second layer L2, respectively. The first layer L1 may include the first track lines TL_1 extending in a Y-axis direction and separated from each other in an X-axis direction. The second layer L2 may include the second track lines TL_2 extending in the X-axis direction and separated from each other in the Y-axis direction. According to various example embodiments as illustrated in FIG. 3A, the first layer L1 and the second layer L2 adjacent in the Z-axis direction may include the first and second track lines TL_1 and TL_2, respectively, and a direction of the first track lines TL_1 included in the first layer L1 may be perpendicular to a direction of the second track lines TL_2 included in the second layer L2. According to some example embodiments, the first and second track lines TL_1 and TL_2 may indicate a region in which signal lines and/or power lines may be arranged.

As shown in FIG. 3A, the first layer L1 may include a number, such as four, first track lines TL_1, and the second layer L2 may include a number, such as four second track lines TL_2. FIG. 3A is only illustrative, and the first layer L1 and the second layer L2 may include four or more first track lines TL_1 and four or more second track lines TL_2, respectively. The number of first track lines TL_1 may be the same as, greater than, or less than the number of second track lines TL_2. A pitch, e.g. a first pitch, of the first track lines TL_1 may be the same as, greater than, or less than a pitch, e.g. a second pitch, of the second track lines TL_2.

In the first layer L1, first power lines PW_1a and PW_1b and second power lines PW_2a and PW_2b arranged along the first track lines TL_1 may be included. According to some example embodiments, the first power lines PW_1a and PW_1b may be power lines to which the first power VDD is to be applied. According to some example embodiments, the second power lines PW_2a and PW_2b may be power lines to which the second power VSS is applied. According to some example embodiments, the second power lines PW_2a and PW_2b may be ground power lines to which a ground voltage is to be applied. As used herein, “ground power line” and “ground line” may be used with the same meaning. The first power lines PW_1a and PW_1b and the second power lines PW_2a and PW_2b may include a metal. Referring to FIG. 3A, the lengths of metals included in first power lines PW_1a′ and PW_1b′ and second power lines PW_2a′ and PW_2b′ arranged in the second layer L2 may be different from the lengths of metals included in the first power lines PW_1a and PW_1b and the second power lines PW_2a and PW_2b arranged in the first layer L1. Referring to FIG. 3A, the first power lines PW_1a and PW_1b may not be electrically connected to the second power lines PW_2a and PW_2b in the first layer L1. Referring to FIG. 3A, the first power lines PW_1a and PW_1b included in the first layer L1 may be electrically connected to the first power lines PW_1a′ and PW_1b′ included in the second layer L2 through first vias VIA_1. The second power lines PW_2a and PW_2b included in the first layer L1 may be electrically connected to the second power lines PW_2a′ and PW_2b′ included in the second layer L2 through second vias VIA_2.

Referring to FIG. 3A, first power lines PW_1a′, PW_1b′, and PW_1c and second power lines PW_2a′, PW_2b′, and PW_2c arranged along the second track lines TL_2 may be included in the second layer L2. Referring to FIG. 3A, in the second layer L2, a signal line SL, through which a signal may be applied to the memory device, may be arranged along a second track line TL_2. According to some example embodiments, the signal line SL may be the signal line formed in the routing operation S150 of FIG. 1. According to some example embodiments, the first power lines PW_1a and PW_1b included in the first layer L1 may be connected to each other through the first power lines PW_1a′, PW_1b′, and PW_1c included in the second layer L2. According to some example embodiments, the second power lines PW_2a and PW_2b included in the first layer L1 may be connected to each other through the second power lines PW_2a′, PW_2b′, and PW_2c included in the second layer L2. Referring to FIG. 3A, the first power lines PW_1a and PW_1b included in the first layer L1 may be electrically connected to the first power lines PW_1a′, PW_1b′, and PW_1c included in the second layer L2 through the first vias VIA_1. The second power lines PW_2a and PW_2b included in the first layer L1 may be electrically connected to the second power lines PW_2a′, PW_2b′, and PW_2c included in the second layer L2 through the second vias VIA_2.

Referring to FIG. 3A, each of the first layer L1 and the second layer L2 adjacent to each other may include track lines on which power lines may be arranged. Adjacent layers may include track lines perpendicular to each other, respectively.

FIG. 3B is a top view of the first layer L1 and the second layer L2 of FIG. 3A. Referring to FIG. 3B, a top view of the perspective view shown in FIG. 3A, which is viewed in the Z-axis direction. Referring to FIG. 3B, in the second layer L2, the first power lines PW_1a′, PW_1b′, and PW_1c, the second power lines PW_2a′, PW_2b′, and PW_2c, and the signal line SL may be arranged along the second track lines TL_2. In the second layer L2, the first power lines PW_1a′, PW_1b′, and PW_1c, the second power lines PW_2a′, PW_2b′, and PW_2c, and the signal line SL may be arranged in the X-axis direction. In the first layer L1, the first power lines PW_1a and PW_1b and the second power lines PW_2a and PW_2b may be arranged in the Y-axis direction that is perpendicular to the X-axis direction in which the first power lines PW_1a′, PW_1b′, and PW_1c and the second power lines PW_2a′, PW_2b′, and PW_2c in the second layer L2 are arranged. According to some example embodiments, as shown in FIG. 3B, in the second layer L2 adjacent to the first layer L1, in which the first power lines PW_1a and PW_1b or the second power lines PW_2a and PW_2b are electrically isolated from each other, the first power lines PW_1a′ and PW_1b′ isolated from the first layer L1 may be connected to each other through the first power line PW_1c, and the second power lines PW_2a′ and PW_2b′ isolated from the first layer L1 may be connected to each other through the second power line PW_2c, thereby reducing a current-resistance (IR) drop.

Although the drawings show that signal lines SL are provided only to some track lines (e.g., the second track lines TL_2) of one layer (e.g., the second layer L2), positions at which the signal lines SL may be arranged are not limited to the drawings. In some example embodiment, the positions at which the signal lines SL may be arranged may be determined in the routing operation S150 of FIG. 1.

According to some example embodiments, the memory device may electrically connect connectable power lines among a plurality of power lines included in the plurality of layers to enable dense connection of the power lines, thereby reducing a short path resistance (SPR) and/or an IR drop, and accordingly, reducing a resistance of the memory device. According to some example embodiments, the memory device according to various example embodiments may additionally connect connectable power lines in a white space after completing signal routing, thereby reducing an IR drop.

Hereinafter, a method of arranging power lines is described in detail with reference to more particular top views.

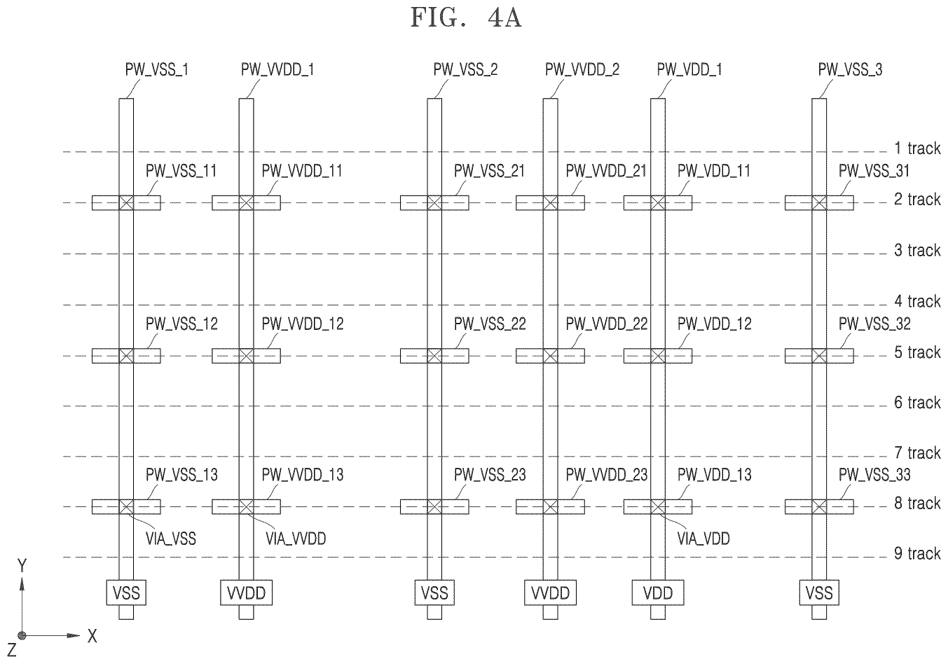

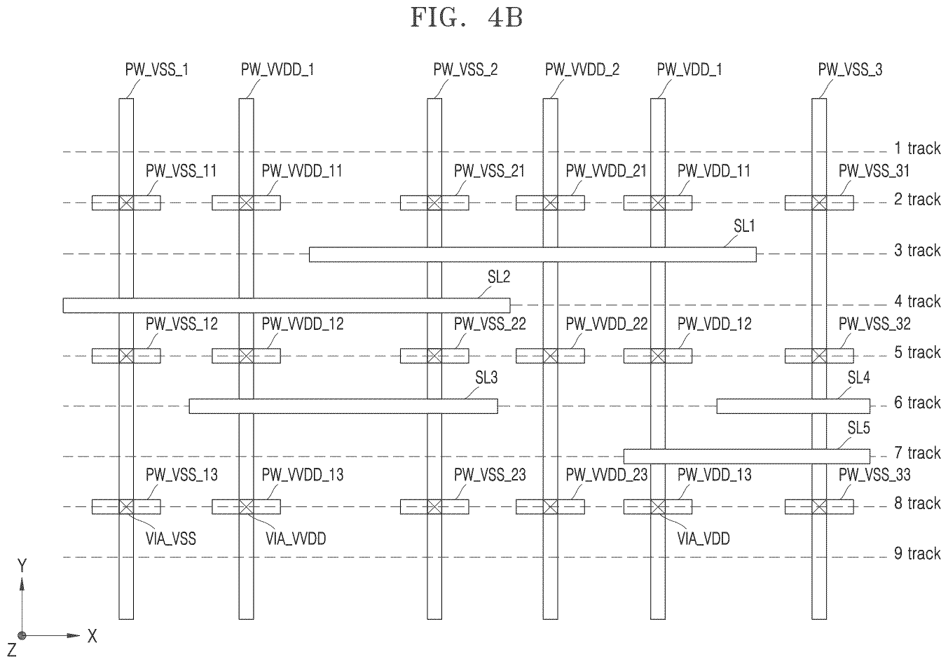

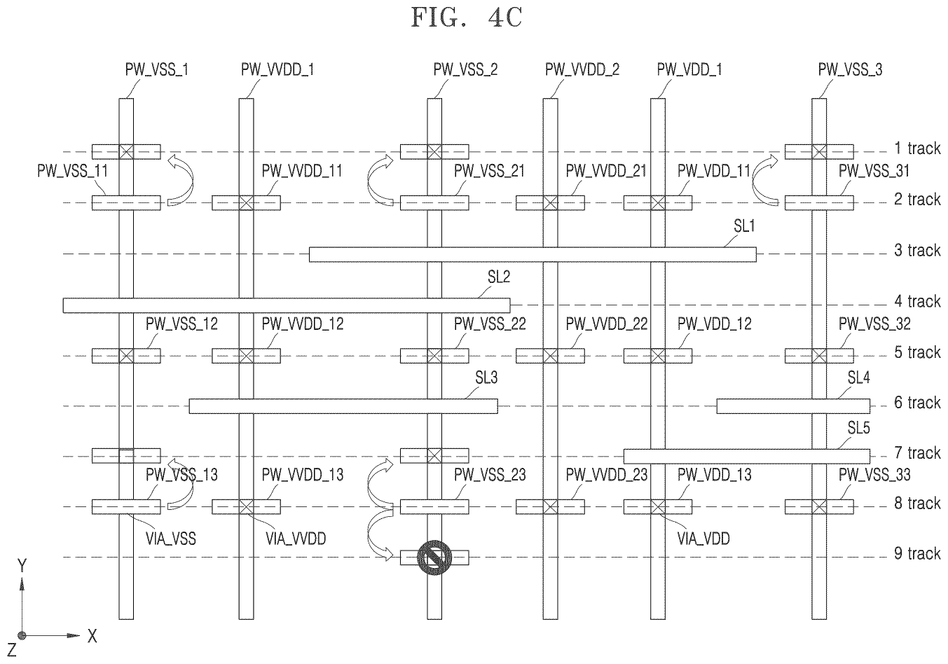

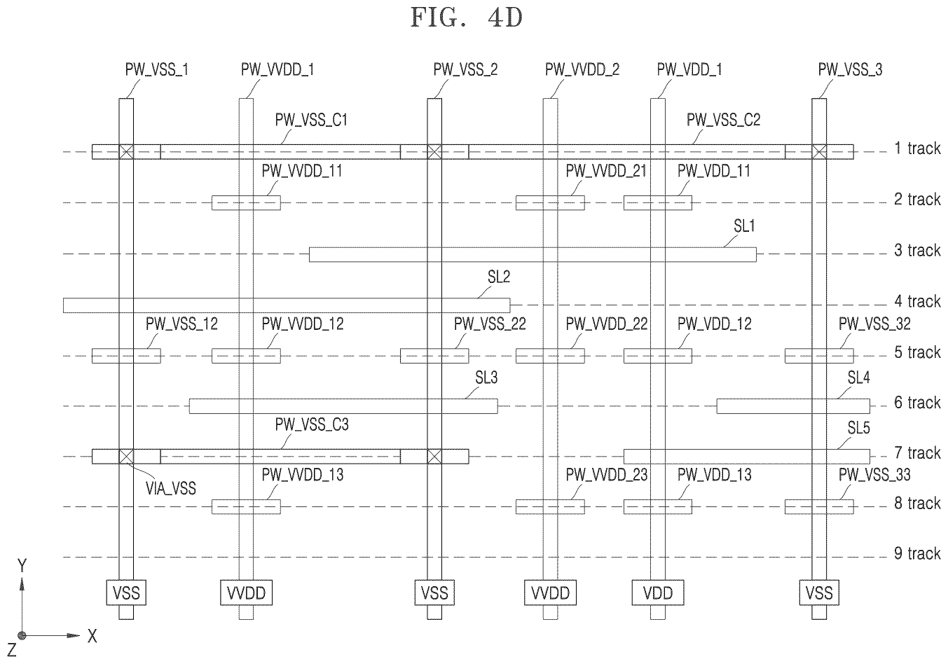

FIGS. 4A to 4D are top views illustrating a method of arranging power lines in a memory device, according to some example embodiments.

FIG. 4A is a top view illustrating a state in which a plurality of power lines are primarily arranged in a memory device, according to some example embodiments. According to some example embodiments, FIG. 4A may be a top view illustrating a state in which power lines are completely arranged in the power plan operation S120 of FIG. 1. Referring to FIG. 4A, power lines arranged by extending in the X-axis direction and power lines arranged by extending in the Y-axis direction are shown. The power lines arranged by extending in the X-axis direction may be arranged in a different layer from a layer in which the power lines arranged by extending in the Y-axis direction are arranged. Hereinafter, to identify power lines arranged in different layers, the power lines arranged by extending in the X-axis direction may be referred to as power line segments, and the power lines arranged by extending in the Y-axis direction may be referred to as power lines. A pitch and/or a width of the power line segments may be the same, or different from, a pitch and/or a width of the power lines.

Referring to FIG. 4A, VSS power line segments PW_VSS_11, PW_VSS_12, PW_VSS_13, PW_VSS_21, PW_VSS_22, PW_VSS_23, PW_VSS_31, PW_VSS_32, and PW_VSS_33, VDD power line segments PW_VDD_11, PW_VDD_12, and PW_VDD_13, and VVDD power line segments PW_VVDD_11, PW_VVDD_12, PW_VVDD_13, PW_VVDD_21, PW_VVDD_22, and PW_VVDD_23 are arranged by extending in the X-axis direction.

The VDD power line segments PW_VDD_11, PW_VDD_12, and PW_VDD_13, the VSS power line segments PW_VSS_11, PW_VSS_12, PW_VSS_13, PW_VSS_21, PW_VSS_22, PW_VSS_23, PW_VSS_31, PW_VSS_32, and PW_VSS_33, and the VVDD power line segments PW_VVDD_11, PW_VVDD_12, PW_VVDD_13, PW_VVDD_21, PW_VVDD_22, and PW_VVDD_23 arranged side by side in the X-axis direction may be arranged on the same track lines extending in the X-axis direction, respectively. According to various example embodiments as in FIG. 4A, the VDD power line segments PW_VDD_11, PW_VDD_12, and PW_VDD_13, the VSS power line segments PW_VSS_11, PW_VSS_12, PW_VSS_13, PW_VSS_21, PW_VSS_22, PW_VSS_23, PW_VSS_31, PW_VSS_32, and PW_VSS_33, and the VVDD power line segments PW_VVDD_11, PW_VVDD_12, PW_VVDD_13, PW_VVDD_21, PW_VVDD_22, and PW_VVDD_23 are respectively arranged on a second track line 2 track, a fifth track line 5 track, and an eighth track line 8 track of an nth layer.

Referring to FIG. 4A, first, second, and third VSS power lines PW_VSS_1, PW_VSS_2, and PW_VSS_3, VVDD power lines PW_VVDD_1 and PW_VVDD_2, and a VDD power line PW_VDD_1 are arranged in the Y-axis direction. According to various example embodiments as illustrated in FIG. 4A, the first, second, and third VSS power lines PW_VSS_1, PW_VSS_2, and PW_VSS_3, the VVDD power lines PW_VVDD_1 and PW_VVDD_2, and the VDD power line PW_VDD_1 arranged in the Y-axis direction may be arranged in an (n+1)th layer. In FIG. 4A, the VDD power line segments PW_VDD_11, PW_VDD_12, and PW_VDD_13, the VSS power line segments PW_VSS_11, PW_VSS_12, PW_VSS_13, PW_VSS_21, PW_VSS_22, PW_VSS_23, PW_VSS_31, PW_VSS_32, and PW_VSS_33, and the VVDD power line segments PW_VVDD_11, PW_VVDD_12, PW_VVDD_13, PW_VVDD_21, PW_VVDD_22, and PW_VVDD_23 arranged in the X-axis direction may be arranged in the nth layer. Herein, n may be a natural number of 1 or greater.

Referring to FIG. 4A, the VDD power line segments PW_VDD_11, PW_VDD_12, and PW_VDD_13, the VSS power line segments PW_VSS_11, PW_VSS_12, PW_VSS_13, PW_VSS_21, PW_VSS_22, PW_VSS_23, PW_VSS_31, PW_VSS_32, and PW_VSS_33, and the VVDD power line segments PW_VVDD_11, PW_VVDD_12, PW_VVDD_13, PW_VVDD_21, PW_VVDD_22, and PW_VVDD_23 may be shorter than the first, second, and third VSS power lines PW_VSS_1, PW_VSS_2, and PW_VSS_3, the VVDD power lines PW_VVDD_1 and PW_VVDD_2, and the VDD power line PW_VDD_1 arranged in the (n+1)th layer. According to some example embodiments, the VDD power line segments PW_VDD_11, PW_VDD_12, and PW_VDD_13, the VSS power line segments PW_VSS_11, PW_VSS_12, PW_VSS_13, PW_VSS_21, PW_VSS_22, PW_VSS_23, PW_VSS_31, PW_VSS_32, and PW_VSS_33, and the VVDD power line segments PW_VVDD_11, PW_VVDD_12, PW_VVDD_13, PW_VVDD_21, PW_VVDD_22, and PW_VVDD_23 may be provided to have a reduced length, e.g. the minimum length from vias VIA_VDD, VIA_VSS, and VIA_VVDD connected to the VDD power line PW_VDD_1, the first, second, and third VSS power lines PW_VSS_1, PW_VSS_2, and PW_VSS_3, and the VVDD power lines PW_VVDD_1 and PW_VVDD_2 respectively corresponding thereto. Lengths of the power line segments may be the same as each other, or may be different from each other; example embodiments are not limited thereto.

Referring to FIG. 4B, an example in which signal lines SL1, SL2, SL3, SL4, and SL5 are added to the top view of FIG. 4A is shown. FIG. 4B may illustrate an operation after the routing operation S150 of FIG. 1 is completed. Referring to FIG. 4B, the signal lines SL1, SL2, SL3, SL4, and SL5 may be routed along track lines of the nth layer. Referring to FIG. 4B, an example in which the signal lines SL1, SL2, SL3, SL4, and SL5 are routed on portions of a third track line 3 track, a fourth track line 4 track, a sixth track line 6 track, and a seventh track line 7 track is shown. According to some example embodiments, the signal lines SL1, SL2, SL3, SL4, and SL5 may be arranged on track lines on which no power line segments are arranged.

Referring to FIG. 4C, an example in which some of the VSS power line segments PW_VSS_11, PW_VSS_12, PW_VSS_13, PW_VSS_21, PW_VSS_22, PW_VSS_23, PW_VSS_31, PW_VSS_32, and PW_VSS_33 are moved to adjacent track lines within a range not interfering with the routed signal lines SL1, SL2, SL3, SL4, and SL5 is shown.

Still referring to FIG. 4C, an example in which the VSS power line segments PW_VSS_11, PW_VSS_21, and PW_VSS_31 arranged on the second track line 2 track are moved to a first track line 1 track, and the VSS power line segments PW_VSS_13 and PW_VSS_23 arranged on the eighth track line 8 track are moved to the seventh track line 7 track is shown.

Still referring to FIG. 4C, for the VSS power line segments PW_VSS_12, PW_VSS_22, and PW_VSS_32 arranged on the fifth track line 5 track, the routed signal lines SL2, SL3, and SL4 are arranged on adjacent fourth and sixth track lines 4 track and 6 track. For the VSS power line segments PW_VSS_12, PW_VSS_22, and PW_VSS_32 arranged on the fifth track line 5 track, the VSS power line segment PW_VSS_32 arranged at the right end may be moved to the fourth track line 4 track, and the VSS power line segment PW_VSS_12 arranged at the left end may be moved to the sixth track line 6 track. However, power lines of the same type (e.g. VSS-type or VDD-type), which are arranged on the same track line, have to be moved in the same direction. Referring to FIG. 4C, if the VSS power line segments PW_VSS_12 and PW_VSS_32 arranged on the fifth track line 5 track are moved to different track lines, e.g., if one (PW_VSS_32) of the VSS power line segments PW_VSS_12, PW_VSS_22, and PW_VSS_32 arranged on the fifth track line 5 track is moved to the fourth track line 4 track, and other one (PW_VSS_12) thereof is moved to the sixth track line 6 track, the moved VSS power line segments PW_VSS_12 and PW_VSS_32 are arranged on different track lines and cannot be electrically connected to each other, and thus, this movement cannot be performed.

Still referring to FIG. 4C, if power line segments on any one track line are moved, all the power line segments have to be moved in the same direction. In example embodiments as in FIG. 4C, the VSS power line segment PW_VSS_13 connected to the first VSS power line PW_VSS_1 through the via VIA_VSS is moved from the eighth track line 8 track to the seventh track line 7 track. In this case, in FIG. 4C, if the VSS power line segment PW_VSS_23 connected to the second VSS power line PW_VSS_2 through the via VIA_VSS is moved from the eighth track line 8 track to a ninth track line 9 track, the VSS power line segment PW_VSS_13 cannot be connected to the VSS power line segment PW_VSS_23, and thus, the VSS power line segment PW_VSS_23 has to be moved to the seventh track line 7 track in the same direction as the VSS power line segment PW_VSS_13.

Still referring to FIG. 4C, all of three VSS power line segments PW_VSS_11, PW_VSS_21, and PW_VSS_31 arranged on the second track line 2 track may be moved to the first track line 1 track. In this case, moving the VSS power line segment PW_VSS_21 arranged at the center among the VSS power line segments PW_VSS_11, PW_VSS_21, and PW_VSS_31 arranged on the second track line 2 track may not be mandatory.

Referring to FIG. 4D, the three VSS power line segments PW_VSS_11, PW_VSS_21 and PW_VSS_31 arranged on the first track line 1 track may be electrically connected to each other through additional metals PW_VSS_C1 and PW_VSS_C2 on the first track line 1 track. In addition, the two VSS power line segments PW_VSS_13 and PW_VSS_23 arranged on the seventh track line 7 track may be electrically connected to each other through an additional metal PW_VSS_C3. By doing this, the first VSS power line PW_VSS_1, the second VSS power line PW_VSS_2, and the third VSS power line PW_VSS_3 may be electrically connected to each other in the nth layer. According to various example embodiments, a white space of a layer in which signal routing has been completed may be used to move power lines and then connect the moved power lines, thereby more efficiently using the white space and reducing an IR drop.

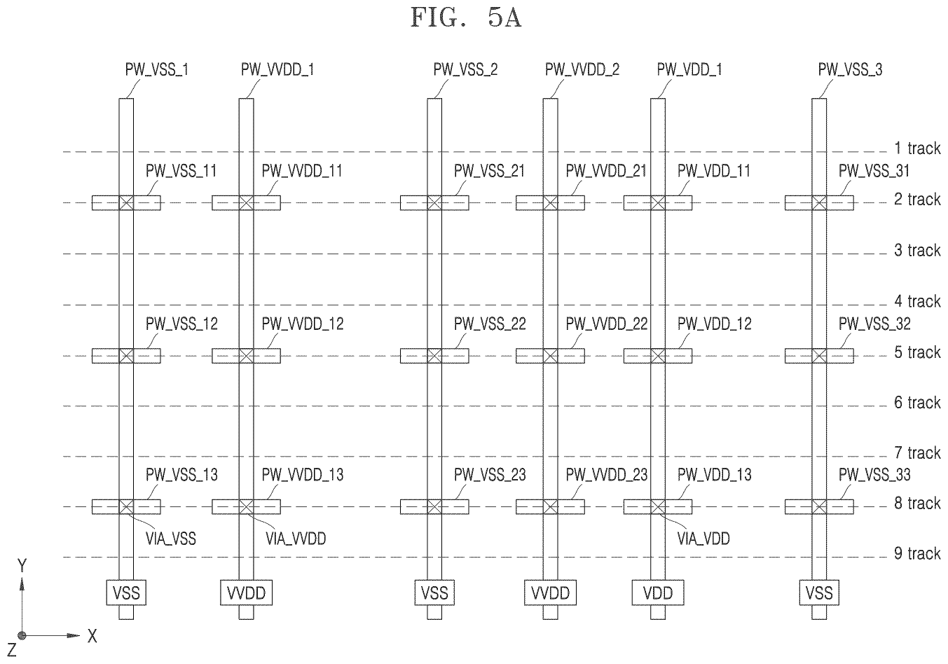

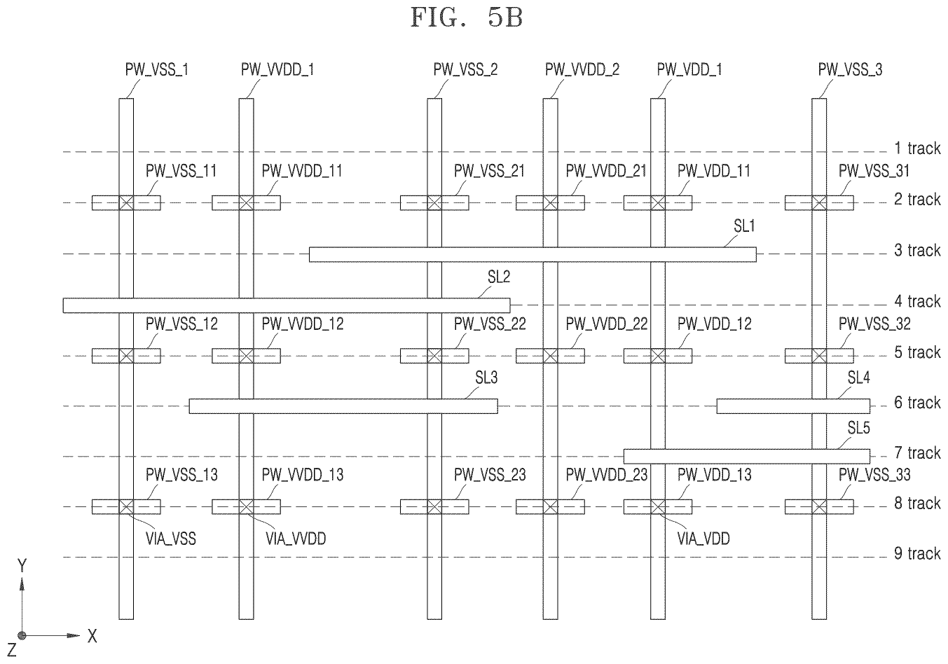

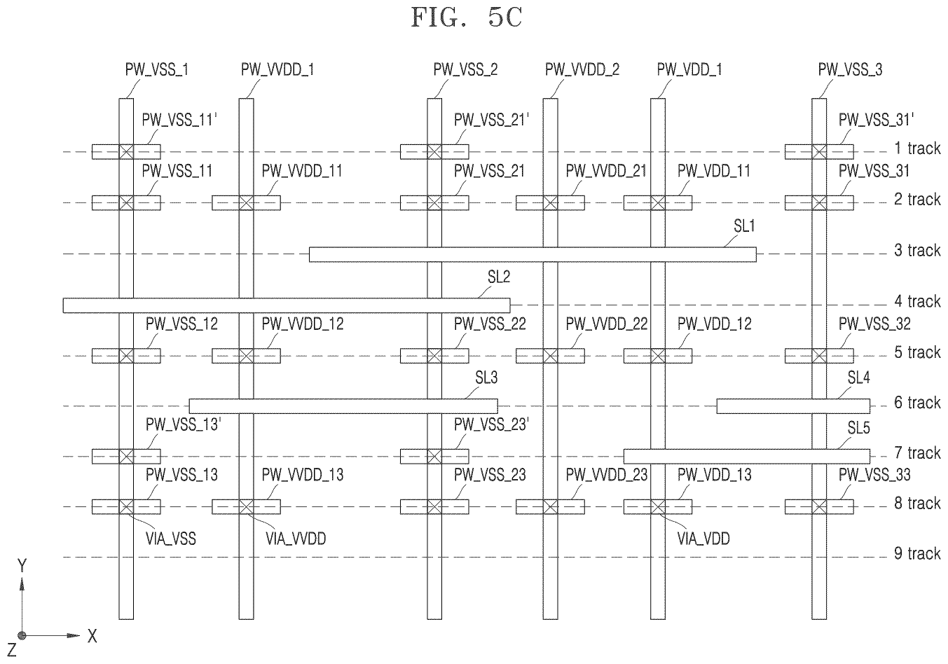

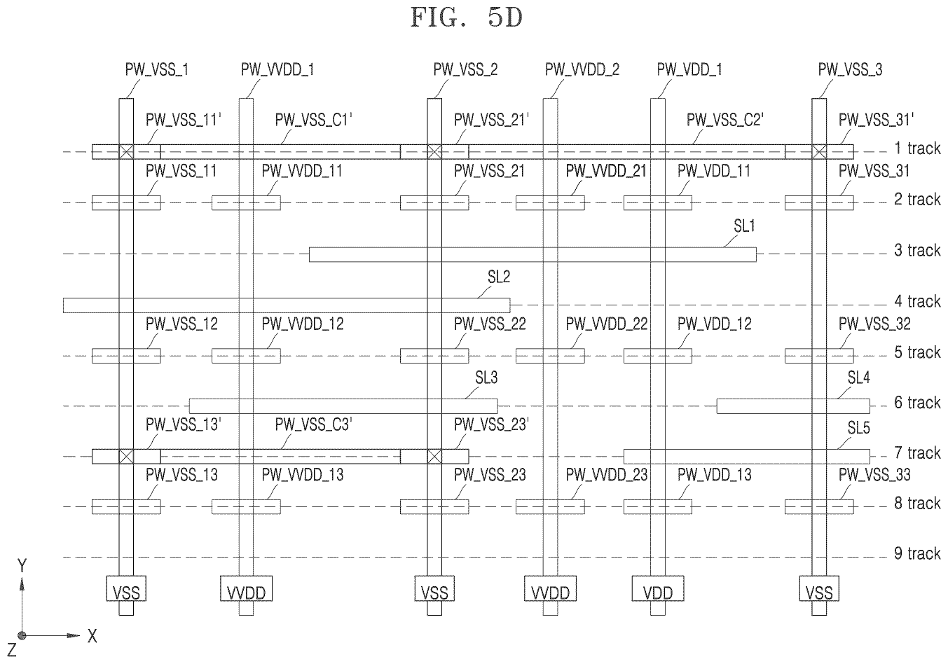

FIGS. 5A to 5D are top views illustrating a method of arranging power lines in a memory device, according to some example embodiments.

In various example embodiments as illustrated in FIGS. 5A to 5D, a description made with reference to FIGS. 4A to 4D may not be repeated.

FIG. 5A is a top view illustrating a state in which the power lines are primarily arranged in the memory device according to some example embodiments, and FIG. 5B is a top view illustrating a state in which signal lines are routed in the memory device according to various embodiments. The top views of FIGS. 5A and 5B may be the same as the top views of FIGS. 4A and 4B.

FIG. 5C shows an example in which VSS power line segments PW_VSS_11′, PW_VSS_21′, PW_VSS_31′, PW_VSS_13′, and PW_VSS_23′ are added to adjacent track lines within a range not interfering with routed signal lines. Referring to FIG. 5C, an example in which the VSS power line segments PW_VSS_11′, PW_VSS_21′, and PW_VSS_31′ are added to the first track line 1 track to which the VSS power line segments PW_VSS_11, PW_VSS_21, and PW_VSS_31 arranged on the second track line 2 track are adjacent is shown. In addition, an example in which the VSS power line segments PW_VSS_13′ and PW_VSS_23′ are added to the seventh track line 7 track to which the VSS power line segments PW_VSS_13 and PW_VSS_23 arranged on the eighth track line 8 track are adjacent is shown.

Referring to FIG. 5C, if it is determined that there is a white space in an adjacent track line to which VSS power line segments are to be added, the VSS power line segments may be added to the adjacent track line.

FIG. 5D is a top view illustrating connection of the VSS power line segments PW_VSS_11′, PW_VSS_21′, PW_VSS_31′, PW_VSS_13′, and PW_VSS_23′ added in FIG. 5C. Referring to FIG. 5D, by electrically connecting the added VSS power line segments PW_VSS_11′, PW_VSS_21′, PW_VSS_31′, PW_VSS_13′, and PW_VSS_23′, the first VSS power line PW_VSS_1, the second VSS power line PW_VSS_2, and the third VSS power line PW_VSS_3 may be electrically connected to each other. Referring to FIG. 5D, the first VSS power line PW_VSS_1 may be connected to the second VSS power line PW_VSS_2 by connecting the VSS power line segments PW_VSS_13′ and PW_VSS_23′ added to the seventh track line 7 track, and the first VSS power line PW_VSS_1, the second VSS power line PW_VSS_2, and the third VSS power line PW_VSS_3 may be connected to each other by connecting the VSS power line segments PW_VSS_11′, PW_VSS_21′, and PW_VSS_31′ added to the first track line 1 track.

According to some example embodiments, as shown in FIGS. 5C and 5D, when power line segments are added, a design-rule check (DRC) may be additionally necessary; however, example embodiments are not limited thereto.

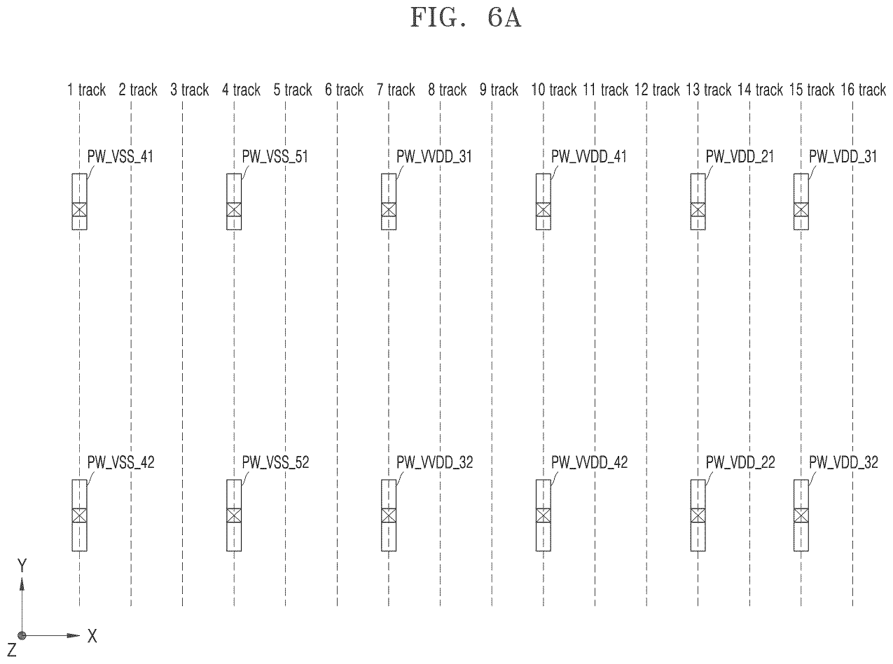

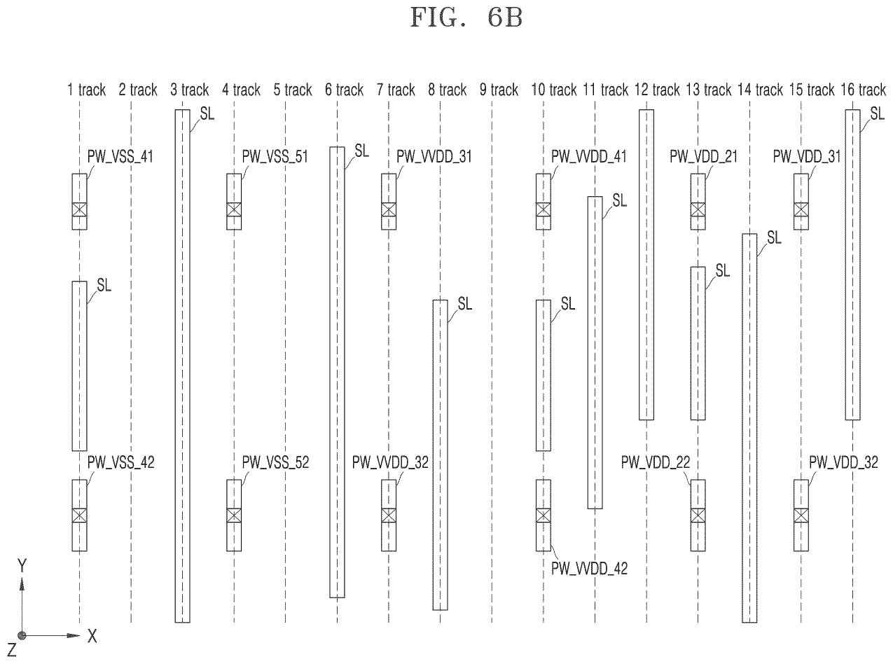

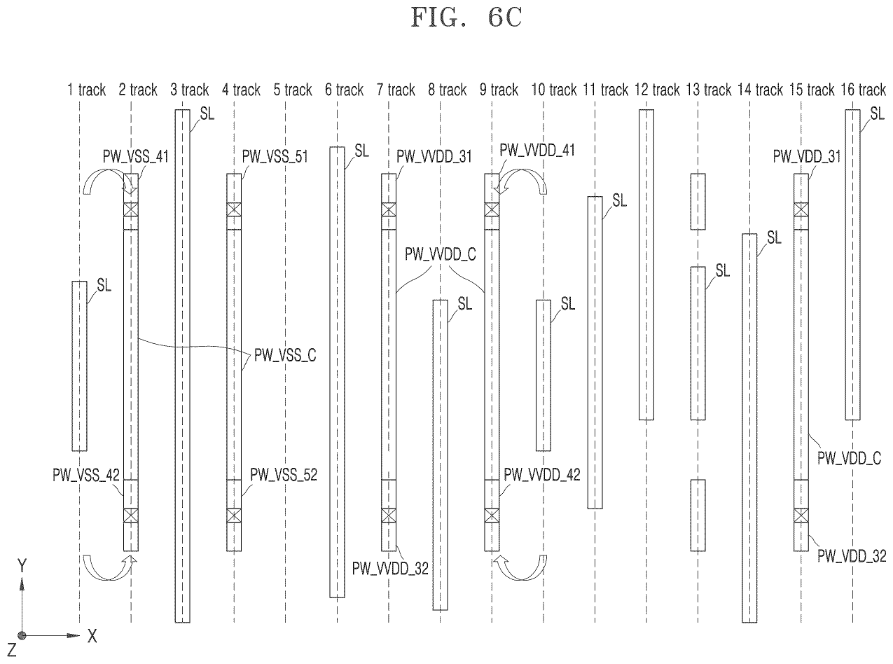

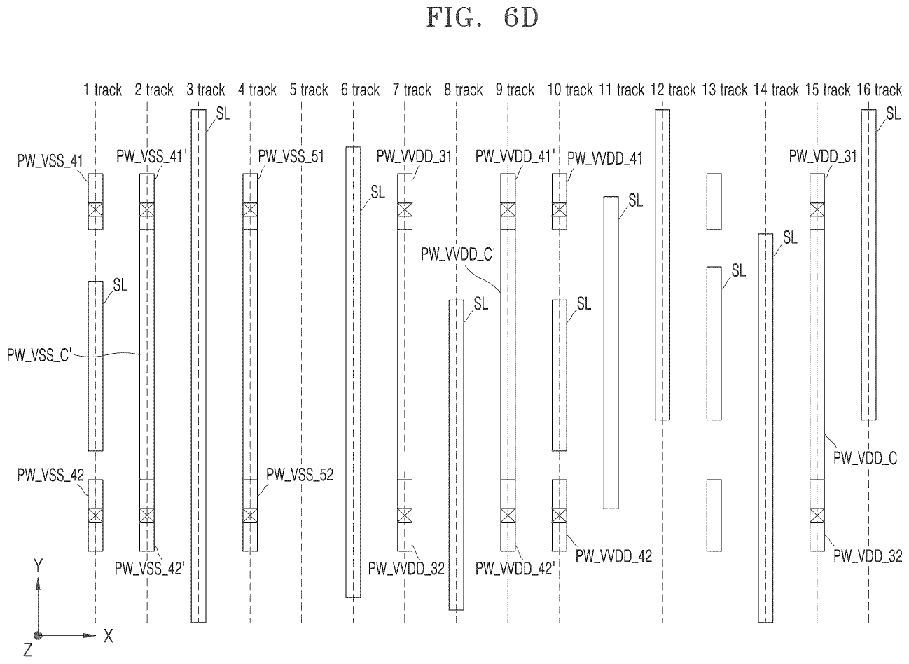

FIGS. 6A to 6D are top views illustrating a method of arranging power lines in a memory device, according to some example embodiments. In the embodiment of FIGS. 6A to 6D, a description made with reference to FIGS. 4A to 4D may not be repeated.

FIG. 6A shows some example embodiments in which three types of power line segments are arranged in the nth layer. The top view of FIG. 6A may be a top view after power line arrangement in a power plan operation ends.

Referring to FIG. 6A, a layer in which track lines extend in the Y-axis direction is shown. Referring to FIG. 6A, the track lines extend in the Y-axis direction, and power line segments PW_VSS, PW_VVDD, and PW_VDD may be arranged on some of the track lines along the track lines. Referring to FIG. 6A, two VSS power line segments PW_VSS_41 and PW_VSS_42 and two VSS power line segments PW_VSS_51 and PW_VSS_52 may be arranged on the first track line 1 track and the fourth track line 4 track, respectively. Two VVDD power line segments PW_VVDD_31 and PW_VVDD_32 and two VVDD power line segments PW_VVDD_41 and PW_VVDD_42 may be arranged on a seventh track line 7 track and a tenth track line 10 track, respectively. Two VDD power line segments PW_VDD_21 and PW_VDD_22 and two VDD power line segments PW_VDD_31 and PW_VDD_32 may be arranged on a thirteenth track line 13 track and a fifteenth track line 15 track, respectively. Although not shown in FIG. 6A, the VSS power line segments PW_VSS_41, PW_VSS_42, PW_VSS_51, and PW_VSS_52 shown in FIG. 6A may be connected via vias (not shown) to VSS power lines (not shown) arranged in an adjacent layer, the VDD power line segments PW_VDD_21, PW_VDD_22. PW_VDD_31, and PW_VDD_32 may be connected via vias (not shown) to VDD power lines (not shown) arranged in the adjacent layer, and the VVDD power line segments PW_VVDD_31, PW_VVDD_32, PW_VVDD_41, and PW_VVDD_42 may be connected via vias (not shown) to VVDD power lines (not shown) arranged in the adjacent layer.

Referring to FIG. 6B, the layer of FIG. 6A to which signal lines are routed is shown. Referring to FIG. 6B, a plurality of signal lines SL may be arranged on various track lines.

FIGS. 6C and 6D illustrate different methods of arranging power lines. FIG. 6C illustrates a method of moving power lines to an adjacent track line and then connecting the moved power lines, according to some example embodiments. FIG. 6D illustrates a method of adding power lines to an adjacent track line and then connecting the added power lines, according to some example embodiments.

Referring to FIG. 6C, the VSS power line segments PW_VSS_41 and PW_VSS_42 arranged on the first track line 1 track may be moved to the second track line 2 track adjacent to the first track line 1 track. Referring to FIG. 6C, because the second track line 2 track adjacent to the first track line 1 track, on which the VSS power line segments PW_VSS_41 and PW_VSS_42 are arranged, is empty, the VSS power line segments PW_VSS_41 and PW_VSS_42 may be moved to the second track line 2 track and then electrically connected through an additional metal PW_VSS_C. Because the VSS power line segments PW_VSS_51 and PW_VSS_52 arranged on the fourth track line 4 track are in a state of being electrically connectable on the fourth track line 4 track even without being moved to an adjacent track line, the VSS power line segments PW_VSS_51 and PW_VSS_52 may be connected on the fourth track line 4 track without being moved to an adjacent track line or adding VSS power line segments.

As in the VSS power line segments PW_VSS_51 and PW_VSS_52 arranged on the fourth track line 4 track, because the VVDD power line segments PW_VVDD_31 and PW_VVDD_32 arranged on the seventh track line 7 track may also be in a state of being electrically connectable even without being moved to an adjacent track line, the VVDD power line segments PW_VVDD_31 and PW_VVDD_32 may be connected without being moved to an adjacent track line or adding VVDD power line segments. An adjacent track line of the tenth track line 10 track, on which the VVDD power line segments PW_VVDD_41 and PW_VVDD_42 are arranged, may be the ninth track line 9 track or an eleventh track line 11 track. If the VVDD power line segments PW_VVDD_41 and PW_VVDD_42 are parallelly moved to the eleventh track line 11 track, the moved VVDD power line segments PW_VVDD_41 and PW_VVDD_42 overlap an already routed signal line SL, and thus, the VVDD power line segments PW_VVDD_41 and PW_VVDD_42 have to be moved to the ninth track line 9 track. Referring to FIG. 6C, the VVDD power line segments PW_VVDD_41 and PW_VVDD_42 arranged on the tenth track line 10 track may be moved to the ninth track line 9 track and then electrically connected to each other. An adjacent track line of the thirteenth track line 13 track, on which the VDD power line segments PW_VDD_21 and PW_VDD_22 are arranged, may be a twelfth track line 12 track or a fourteenth track line 14 track. However, because routed signal lines SL are already arranged in regions of the fourteenth track line 14 track and the twelfth track line 12 track to which the VDD power line segments PW_VDD_21 and PW_VDD_22 are to be parallelly moved, the VDD power line segments PW_VDD_21 and PW_VDD_22 cannot be moved. Because the VDD power line segments PW_VDD_31 and PW_VDD_32 arranged on the fifteenth track line 15 track are in a state of being electrically connectable without being moved to an adjacent track line, the VDD power line segments PW_VDD_31 and PW_VDD_32 may be electrically connected to each other via an additional metal PW_VDD_C on the fifteenth track line 15 track.

FIG. 6D illustrates an example in which power line segments are added to positions, to which power line segments are to be moved, and then connected without power line segment movement. The VSS power line segments PW_VSS_51 and PW_VSS_52 arranged on the fourth track line 4 track, the VVDD power line segments PW_VVDD_31 and PW_VVDD_32 arranged on the seventh track line 7 track, and the VDD power line segments PW_VDD_31 and PW_VDD_32 arranged on the fifteenth track line 15 track, which are electrically connectable without being moved, may be electrically connected via additional metals on corresponding track lines, respectively.

Referring to FIG. 6D, power line segments PW_VSS_41′, PW_VSS_42′, PW_VVDD_41′, and PW_VVDD_42′ having the same lengths as the power line segments PW_VSS_41, PW_VSS_42, PW_VVDD_41, and PW_VVDD_42 may be added instead of movement to positions of adjacent track lines to which the power line segments PW_VSS_41, PW_VSS_42, PW_VVDD_41, and PW_VVDD_42 are to be moved in FIG. 6C, and then electrically connected on the adjacent track lines, respectively.

Although FIG. 6D shows that the added power line segments PW_VSS_41′, PW_VSS_42′, PW_VVDD_41′, and PW_VVDD_42′ have the same length, inventive concepts are not limited thereto.

Referring to the embodiment of FIGS. 6A to 6D, the same power line arrangement method as described above may be applied even to a layer including track lines extending in the Y-axis direction.

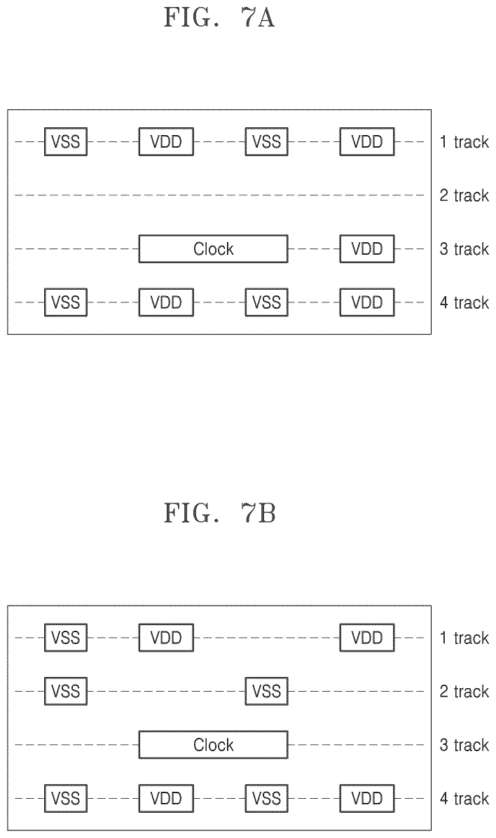

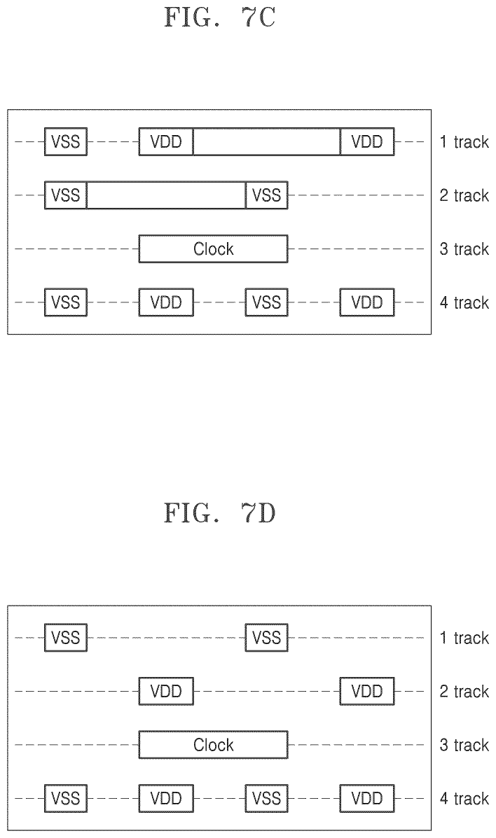

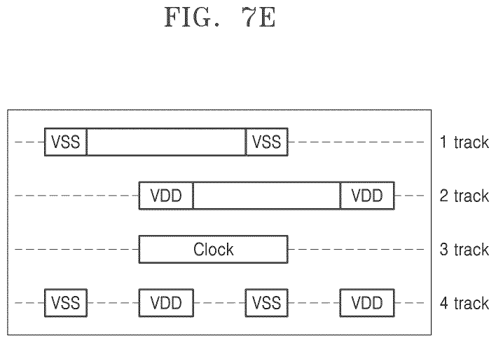

FIGS. 7A to 7E are top views illustrating a method of arranging power lines in a memory device, according to some example embodiments.

In various example embodiments as in FIGS. 7A to 7E, a description made with reference to FIGS. 4A to 4D may not be repeated.

Referring to FIG. 7A, four track lines extending in the X-axis direction are shown in a layer. On the first track line 1 track of FIG. 7A, VSS power line segments VSS and VDD power line segments VDD are arranged. The second track line 2 track is empty, and a routed signal line CLOCK is arranged on the third track line 3 track. On the fourth track line 4 track, VSS power line segments VSS and VDD power line segments VDD are arranged. FIG. 7A may show a layer in a routing completion state.

FIG. 7B shows some example embodiments in which one of the VSS power line segments VSS arranged on the first track line 1 track is moved to the second track line 2 track, and a VSS power line segment VSS is added to the second track line 2 track. Referring to FIG. 7B, for the VSS power line segment VSS arranged at the leftmost among the VSS power line segments VSS arranged on the first track line 1 track, the same VSS power line segment VSS may be added to the second track line 2 track adjacent to the first track line 1 track. Referring to FIG. 7B, the VSS power line segment VSS arranged in the middle among the VSS power line segments VSS arranged on the first track line 1 track may be moved to the second track line 2 track adjacent to the first track line 1 track.

Referring to FIG. 7B, some of a plurality of power line segments included in the same track line may be added to an adjacent track line, and other some thereof may be moved to the adjacent track line.

Referring to FIG. 7B, if the VSS power line segments VSS and the VDD power line segments VDD arranged on the fourth track line 4 track are moved to the third track line 3 track adjacent to the fourth track line 4 track, the moved VSS power line segments VSS and VDD power line segments VDD cannot be connected to each other due to the routed signal line CLOCK arranged on the third track line 3 track, and thus, the VSS power line segments VSS and the VDD power line segments VDD on the fourth track line 4 track cannot be moved.

Referring to FIG. 7C, the VSS power line segment VSS added to the second track line 2 track in FIG. 7B may be connected to the VSS power line segment VSS moved to the second track line 2 track in FIG. 7B, and the VDD power line segments VDD remaining on the first track line 1 track may be connected to each other.

FIG. 7D shows some example embodiments in which the VDD power line segments VDD arranged on the first track line 1 track are moved to the second track line 2 track. Referring back to FIG. 7A, if all of the VSS power line segments VSS and the VDD power line segments VDD are movable to an adjacent track line, the VSS power line segment VSS may be moved as shown in FIG. 7B, or the VDD power line segments VDD may be moved as shown in FIG. 7D.

Referring to FIG. 7E, the VDD power line segments VDD moved to the second track line 2 track in FIG. 7D may be connected to each other, and the VSS power line segments VSS remaining on the first track line 1 track may be connected to each other.

In various embodiments related to power line arrangement, which are shown in FIGS. 3A to 7E, examples in which VDD power lines, VSS power lines, and VVDD power lines are arranged in a layer have been described, but example embodiments are not limited thereto. According to various example embodiments, besides the three types of power lines, additional power lines may be arranged in the layer, and a power line arrangement method according to various example embodiments may also be applied to other power lines besides the illustrated VDD power lines, VSS power lines, and VVDD power lines.

A type of power line in various example embodiments may be any one of a ground power line (VSS power line), a virtual power line (VVDD power line), and a real power line (VDD power line). According to some example embodiments, a VDD power line and a VSS power line may be power lines applied to a non-power gating block. According to some example embodiments, a VVDD power line, a VDD power line and a VSS power line may be power lines applied to a power gating block.

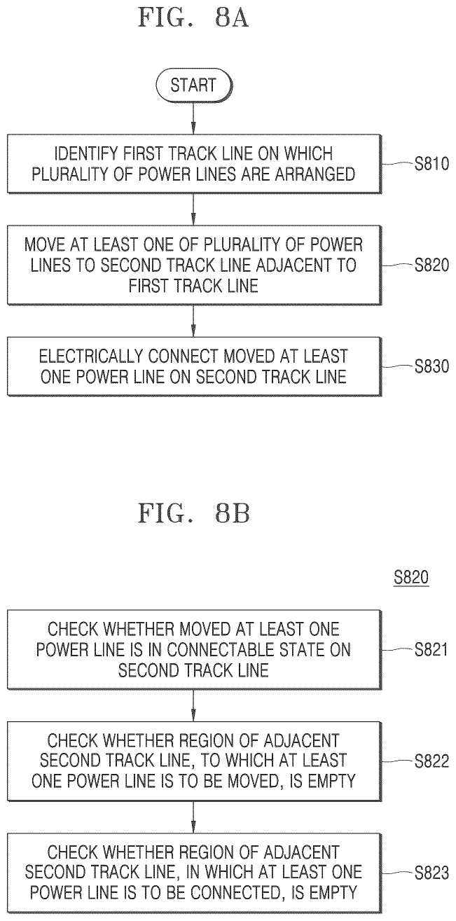

FIGS. 8A and 8B are flowcharts illustrating a power line arrangement method according to some example embodiments.

Referring to FIG. 8A, the power line arrangement method according to some example embodiments may include operation S810 of identifying a first track line on which a plurality of power lines are arranged. Herein, the plurality of power lines may be any one type of power lines among VSS power lines, VDD power lines, and VVDD power lines.

If the first track line, on which the plurality of power lines are arranged, is identified, at least one of the plurality of power lines may be moved to a second track line adjacent to the first track line in operation S820. Thereafter, the moved at least one power line may be electrically connected on the second track line in operation S830. In operation S830, the number of moved power lines may be at least one. If the number of moved power lines is one, the same type of power line connectable to the moved power line may already exist on the adjacent track line. If the number of moved power lines is plural, the plurality of power lines moved to the adjacent track line may be connected to each other.

FIG. 8B is a detailed flowchart illustrating a method of moving a power line to the adjacent second track line.

To move power lines to the adjacent second track line, it is needed to check in operation S821 whether the moved power lines are connectable on the second track line. Herein, if it is checked that the moved power lines are connectable on the second track line, the power lines may be moved to the second track line.

As a method of checking whether a moved power line is connectable on the second track line, it may be checked in operation S822 whether a region of the adjacent second track line to which at least one power line is to be moved is empty. Herein, if a signal line or another power line is arranged in the region of the adjacent second track line to which the at least one power line is to be parallelly moved, it cannot be considered that the moved power lines are connectable on the second track line.

As a method of checking whether the moved power line is connectable on the second track line, it may be checked in operation S823 whether a region of the adjacent second track line in which at least one power line is connectable to another power line is empty. Even though the region of the adjacent second track line to which the at least one power line is to be parallelly moved is empty in operation S822, it has to be additionally checked whether the at least one power line is connectable to the same type of power line on the second track line after the parallel movement.

Thereafter, if it is determined that the moved at least one power line is connectable to the same type of power line on the second track line, the at least one of the plurality of power lines may be moved to the second track line.

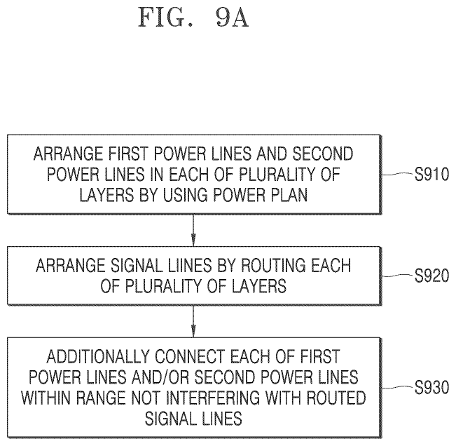

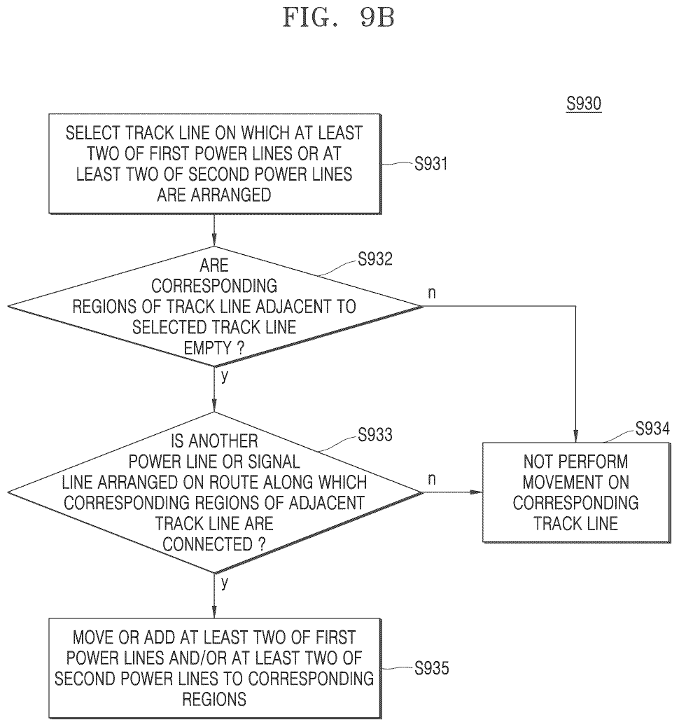

FIGS. 9A and 9B are flowcharts illustrating a power line arrangement method according to some example embodiments.

Referring to FIG. 9A, first power lines and second power lines may be arranged in each of a plurality of layers by using a power plan in operation S910. Operation S910 may correspond to the top views of FIGS. 4A and 5A.

Thereafter, routing may be performed for each of the plurality of layers to arrange signal lines in operation S920. According to various example embodiments, routing may be performed to arrange signal lines, through which a clock signal and other signals to be applied to the memory device may be transferred, in the plurality of layers.

When operation S920 ends, a white space, i.e., empty track lines, may be identified. According to various example embodiments, power lines may be moved or added to an empty track line and electrically connected to reduce an IR drop, thereby performing efficient arrangement in terms of design.

For example, each of first power lines and/or second power lines may be additionally connected within a range not interfering with the routed signal lines in operation S930. According to some example embodiments, power lines connected in a layer through movement and addition have to be the same type of power lines. According to some example embodiments, a first power lines cannot be connected to a second power line.

FIG. 9B is a detailed flowchart of operation S930.

Referring to FIG. 9B, a process of selecting a track line, on which a power line is to be rearranged, may be necessary. Referring to operation S931 of FIG. 9B, a track line, on which at least two of the first power lines or at least two of the second power lines are arranged, may be selected as a track line on which a power line is to be rearranged. Limiting at least two of the first power lines or at least two of the second power lines may indicate a case where, because an adjacent track line is empty, electrical connection is possible only if at least two power lines are moved.

If a track line is selected in operation S931, it may be checked in operation S932 whether corresponding regions of a track line adjacent to the selected track line are empty. Herein, the corresponding regions may indicate regions of the adjacent track line, to which at least two of the first power lines are to be parallelly moved, or regions of the adjacent track line, to which at least two of the second power lines are to be parallelly moved. If all of the regions, to which at least two of the first power lines are to be parallelly moved, or the regions, to which at least two of the second power lines are to be parallelly moved, are not empty, power line rearrangement may not be performed for a corresponding track line in operation S934.

If it is checked that the corresponding regions of the track line adjacent to the selected track line are empty, it may be checked in operation S933 whether another power line or a signal line is arranged on a route along which the corresponding regions of the adjacent track line are connected. If another type of power line or a signal line is arranged on the route along which the corresponding regions on a corresponding track line are connected, even though the corresponding regions are empty, electrical connection of the corresponding regions is impossible, and thus, power line rearrangement may not be performed for the corresponding track line in operation S934.

If another power line or a signal line is not arranged on the route along which the corresponding regions of the adjacent track line are connected, at least two of the first power lines and/or at least two of the second power lines may be moved or added to the corresponding regions in operation S935.

According to some example embodiments, if all of at least two of the first power lines and at least two of the second power lines are moved to the corresponding regions, the at least two of the first power lines and the at least two of the second power lines may be moved to opposite directions, or either the at least two of the first power lines or the at least two of the second power lines may be moved to the corresponding regions. If all of the at least two of the first power lines and the at least two of the second power lines are moved in the same direction, only an arranged track line is different, but electrical connection is impossible as well, and thus, the at least two of the first power lines and the at least two of the second power lines may be moved to opposite directions, or either the at least two of the first power lines or the at least two of the second power lines may be moved or added to the corresponding regions.

According to some example embodiments, the same type of power lines as the at least two of the first power lines or the at least two of the second power lines may be added to the corresponding regions and then connected to each other.

The power line arrangement methods of the flowcharts shown in FIGS. 8A to 9B may be performed after signal lines are routed in each of the plurality of layers. Performing the arrangement after the routing may indicate performing the arrangement after the signal lines are completely arranged. Herein, the routing may be either initial routing or final routing. Herein, the initial routing may indicate a time point at which the signal lines are completely arranged for the first time. The final routing may indicate a time point at which the signal lines are arranged and then other cells are completely arranged.

The various operations of the methods described above may be performed by arbitrary suitable means, such as various kinds of hardware and/or software implemented as a partial form of hardware (e.g., a processor, an application specific integrated circuit (ASIC), or the like), capable of performing the operations.

The software may include a list of aligned executable instructions for implementing logical functions and may be embedded in an arbitrary “process-readable medium” to be used by or in relation to an instruction execution system, device, or equipment, such as a single- or multi-core processor or a processor-included system.

In the specification, the term “storage medium”, “computer-readable storage medium”, or “non-transitory computer-readable storage medium” may include one or more devices storing data, e.g., devices including read-only memory (ROM), random access memory (RAM), magnetic RAM (MRAM), core memory, magnetic disk storage media, optical storage media, flash memory devices and/or other tangible machine-readable media storing information. The term “computer-readable medium” may include, as a non-limiting example, portable or stationary storage devices, optical storage devices, and various other media capable of storing, containing, or carrying instruction(s) and/or data.

Furthermore, embodiments may be implemented by hardware, software, firmware, middleware, microcode, hardware description languages (HDLs), or an arbitrary combination thereof. When the embodiments are implemented by software, firmware, middleware, or microcode, program code or code segments for performing necessary tasks may be stored in a machine- or computer-readable medium, such as a computer-readable storage medium. When the embodiments are implemented by software, a processor or processors may be programmed to perform necessary tasks, and by doing this, the programmed processor or processors may be converted into a special-purpose processor(s) or computer(s).

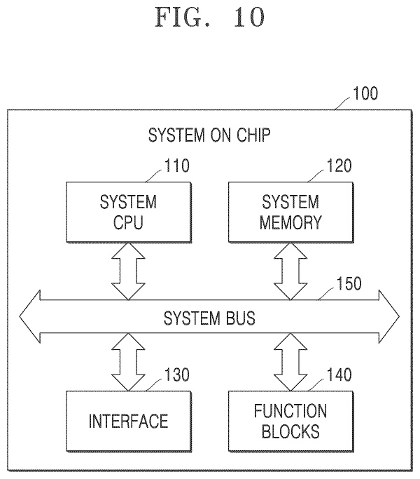

FIG. 10 is a block diagram of a system on chip (SOC) 100 according to some example embodiments. Referring to FIG. 10, the SOC 100 may include a central processing unit (CPU) 110, a system memory 120, an interface 130, function blocks 140, and a bus 150 connecting them. The CPU 110 controls an operation of the SOC 100. The CPU 110 may include a core and an L2 cache. For example, the CPU 110 may include multiple cores. Each core of the multiple cores may have the same or different function. In addition, each core of the multiple cores may be activated at the same time or at a different time point. The system memory 120 may store, by control of the CPU 110, results processed by the function blocks 140. For example, contents stored in the L2 cache of the CPU 110 may be flushed and stored in the system memory 120. The interface 130 may be interfaced with external devices. For example, the interface 130 may be interfaced with a camera, a liquid crystal display (LCD), a speaker, and the like.

The function blocks 140 may perform various functions required for the SOC 100. For example, the function blocks 140 may perform a video codec or process three-dimensional (3D) graphics.

The SOC 100 according to some example embodiments may additionally arrange a power line to use a white space remaining after signal routing is completed, thereby reducing an IR drop.

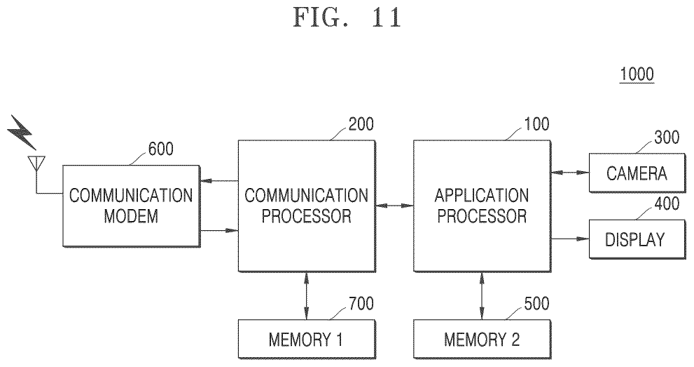

FIG. 11 is a block diagram of a mobile device 1000 according to some example embodiments. Referring to FIG. 11, the mobile device 1000 may include an application processor 100 implemented by an SOC, a communication processor 200, a camera 300, a display 400, a communication modem 600, and memories 500 and 700. In the mobile device 1000, an application may be executed by the application processor 100. For example, when an image is captured by the camera 300, the application processor 100 may store the captured image in the memory 500 and display the captured image on the display 400. The captured image may be transmitted to the outside via the communication modem 600 by control of the communication processor 200. In this case, the communication processor 200 may temporarily store the captured image in the memory 700 to transmit the captured image. The communication processor 200 may also control communication for a call and data transmission and reception.

The mobile device 1000 according to some example embodiments may additionally arrange a power line to use a white space remaining after signal routing is completed, thereby reducing an IR drop.

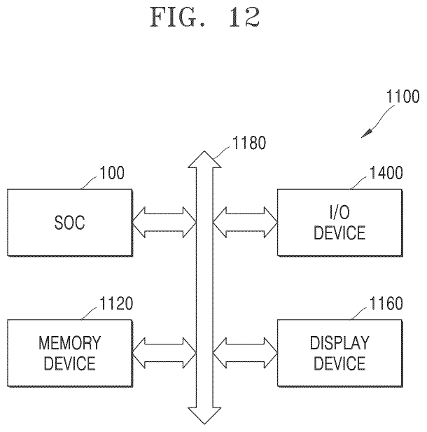

FIG. 12 is a block diagram illustrating a computing system 1100 including the SOC 100 according to some example embodiments. The SOC 100 according to some example embodiments may be mounted in the computing system 1100, such as a mobile device, a desk-top computer, or a server.

In addition, the computing system 1100 may further include a memory device 1120, an input/output (I/O) device 1140, and a display device 1160, and each of these components may be electrically connected to a bus 1180. The computing system 1100 according to some example embodiments may additionally arrange a power line to use a white space remaining after signal routing is completed, thereby reducing an IR drop.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts have been particularly shown and described with reference to some example embodiments thereof, it will be understood that various changes in form and details may be made therein without departing from the spirit and scope of the following claims. Furthermore example embodiments are not necessarily mutually exclusive. For example, some example embodiments may include one or more features described with reference to one or more figures and may also include one or more other features described with reference to one or more other figures.

What is claimed is:

1. A power line arrangement method of arranging power lines to be applied to a memory device comprising a plurality of layers,
wherein, in each of the plurality of layers, a plurality of power lines and a plurality of signal lines are arranged along a plurality of track lines that are side-by-side so as to be separated from each other in a first direction or a second direction that is perpendicular to the first direction, the power line arrangement method comprising:
identifying a first track line on which at least some of the plurality of power lines are arranged;
moving at least one of the at least some of the plurality of power lines to a second track line adjacent to the first track line; and
electrically connecting the moved at least one power line on the second track line.

2. The power line arrangement method of claim 1, wherein the moving the at least one of the plurality of power lines to the second track line adjacent to the first track line comprises,
checking whether the moved at least one power line is in a connectable state on the second track line, and
moving the at least one power line to the second track line upon determining that the at least one power line is in the connectable state.

3. The power line arrangement method of claim 1, wherein the identifying the first track line on which the plurality of power lines are arranged comprises electrically connecting the plurality of power lines on the first track line upon determining that an electrical connection on the first track line is possible.

4. The power line arrangement method of claim 2, wherein the checking whether the moved at least one power line is in the connectable state on the second track line comprises checking whether a region of the adjacent second track line, to which the at least one power line is to be moved, is empty.

5. The power line arrangement method of claim 2, wherein the checking whether the moved at least one power line is in the connectable state on the second track line comprises checking whether a region of the adjacent second track line, in which the at least one power line is connectable to another power line, is empty.

6. The power line arrangement method of claim 2, wherein, if the moved at least one power line is determined to be in the connectable state on the second track line, the at least one of the plurality of power lines is moved to the second track line.

7. The power line arrangement method of claim 1, further comprising:
routing each of the plurality of signal lines in each of the plurality of layers before the identifying a first track line.

8. The power line arrangement method of claim 7, wherein the routing is either initial routing or final routing.

9. The power line arrangement method of claim 1, wherein the plurality of power lines are any one or more types of a ground power line, a virtual power line, and a real power line.

10. A power line arrangement method comprising:
arranging first power lines and second power lines on each of a plurality of layers by using a power plan;
arranging signal lines by routing each of the plurality of layers; and
connecting each of the first power lines and/or the second power lines within a range not interfering with the routed signal lines.

11. The power line arrangement method of claim 10, wherein
each of the first power lines, the second power lines, and the signal lines is arranged along a track line in the layer, and
the connecting each of the first power lines and/or the second power lines within the range not interfering with the routed signal lines comprises selecting a track line on which at least two of the first power lines and/or at least two of the second power lines are arranged.

12. The power line arrangement method of claim 11, further comprising:
checking whether corresponding regions of a track line adjacent to the selected track line are empty.

13. The power line arrangement method of claim 12, wherein the corresponding regions are regions of the adjacent track line to which the at least two of the first power lines are to be parallelly movable, and/or regions of the adjacent track line to which the at least two of the second power lines are to be parallelly movable.

14. The power line arrangement method of claim 13, further comprising,
if the corresponding regions of the track line adjacent to the selected track line are determined to be empty, checking whether another power line or a signal line is arranged on a route along which the corresponding regions of the adjacent track line are connected.

15. The power line arrangement method of claim 14, further comprising, if another power line or a signal line is not arranged on the route along which the corresponding regions of the adjacent track line are connected, moving or adding the at least two of the first power lines and/or the at least two of the second power lines to the corresponding regions.

16. The power line arrangement method of claim 15, wherein, if all of the at least two of the first power lines and the at least two of the second power lines are moved to the corresponding regions, the at least two of the first power lines and the at least two of the second power lines are moved in opposite directions.

17. The power line arrangement method of claim 14, further comprising, if another power line or a signal line is not arranged on the route along which the corresponding regions of the adjacent track line are connected, adding the same type of power lines as the at least two of the first power lines or the at least two of the second power lines and connecting the added power lines to each other.

18. The power line arrangement method of claim 10, wherein the first power line comprises a virtual power line or a real power line, and the second power line comprises a ground line.

19. A memory device comprising a plurality of layers comprising:
a first layer in which a plurality of first power lines and a plurality of first ground lines are arranged along a plurality of first track lines in a first direction; and
a second layer in which a plurality of second power lines and a plurality of second ground lines are arranged along a plurality of second track lines in a second direction that is perpendicular to the first direction, and which is adjacent to the first layer in a direction perpendicular to the first and second directions,
wherein a first power line arranged in the first layer is connected with a second power line arranged in the second layer through a first via, a first ground line arranged in the first layer is connected with a second ground line arranged in the second layer through a second via, the plurality of first power lines or the plurality of first ground lines arranged in the first layer are electrically isolated in the first layer, and each of at least some of the plurality of second power lines or at least some of the plurality of second ground lines arranged in the second layer is electrically connected in the second layer.

20. The memory device in claim 19, wherein the first power line comprises at least one of a virtual power line or a real power line.
